(19) United States
(12) Patent Application Publication
(10) Pub. No.: US 2004/0209577 A1
(43) Pub. Date: Oct. 21, 2004

(54) Portable wireless terminal including a moveable camera lens unit

(75) Inventors: Seung-Min Park, Seoul (KR); Chang-Soo Lee, Incheon (KR); Sung-Kwon Kim, Gwangmyeong-si (KR); Jun-Sang Park, Anyang-si (KR); Jun Kim, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/804,535

(22) Filed: Mar. 19, 2004

(30) Foreign Application Priority Data
Apr. 15, 2003 (KR) 23731/2003

(51) Int. Cl. G06K 7/10

(52) U.S. Cl. 455/90.3

(57) ABSTRACT

A portable wireless terminal comprising a first housing and a second housing. The first housing has an upper end curved in the shape of a semicircle, an open lower end, a slit circumferentially formed along the upper end, and a receiving space defined therein and extended inwardly from the open lower end in the longitudinal direction thereof. The second housing is inserted into or drawn out from the receiving space of the first housing. In the first housing is mounted a camera lens unit. The camera lens unit has an exposure window circumferentially movable along the slit formed at the upper end of the first housing. In addition, the camera lens unit can be rotated in the range of 180 degrees, whereby the portable wireless terminal is very useful for a multimedia environment of a mobile communication service.

### PRIORITY

This application claims priority to an application entitled “PORTABLE WIRELESS TERMINAL”, filed in the Korean Intellectual Property Office on Apr. 15, 2003 and assigned Serial No. 2003-23731, the contents of which are hereby incorporated by reference.

### BACKGROUND OF THE INVENTION

1. Field of the Invention

The present invention relates generally to a portable wireless terminal, and more particularly to a sliding-type terminal with a camera lens unit movable along the edge of the terminal.

2. Description of the Related Art

Generally, “portable wireless terminals” are devices that are portable and enable owners of the devices to communicate in a wireless manner. Such portable wireless terminals have become increasingly small and lightweight, whereby portability thereof is improved. Furthermore, such portable wireless terminals are now capable of performing various additional functions. Future portable wireless terminals will be miniaturized, more lightweight, multipurpose terminals with various functions, which will be easily adapted to various multimedia and Internet environments.

Physically, the portable wireless terminals may be classified into several types of terminals. For example, the portable wireless terminals may be classified into a bar-type terminal, a flip-type terminal, or a folder-type terminal. The bar-type terminal has a bar-type single housing, the flip-type terminal comprises a bar-type housing and a flip part pivotably attached to the housing, and the folder-type terminal comprises a bar-type housing and a folder part pivotably attached to the housing.

According to how they are opened or closed, the portable wireless terminals may be further classified into a rotating-type terminal and a sliding-type terminal. The rotating-type terminal is characterized in that two housings are rotatably connected to each other while the housings are continuously opposite to each other. The rotating-type terminal is opened or closed by the rotation of the two housings in such a manner that the housings are rotated apart from or close to each other. Alternatively, the sliding-type terminal is characterized in that two housings are longitudinally slid. The sliding-type terminal is opened or closed by the sliding movement of the two housings in such a manner that the housings are slid apart from or close to each other. The above-described various types of wireless terminals are easily appreciated by a person having an ordinary skill in the art to which the present invention pertains.

However, special emphasis is attached to simple changes of designs in the conventional portable wireless terminals regardless of the fact that criteria of choosing terminals have been diversified as the terminals are popularized. Consequently, the conventional portable wireless terminals do not satisfy various desires of users.

### SUMMARY OF THE INVENTION

Therefore, the present invention has been designed in view of the above and other problems, and it is an object of the present invention to provide a portable wireless terminal, which is capable of satisfying various desires of users.

It is another object of the present invention to provide a portable wireless terminal, which is miniaturized and thus easily carried.

It is yet another object of the present invention to provide a portable wireless terminal including a camera lens unit, which is capable of taking pictures at various angles.

In accordance with one aspect of the present invention, the above and other objects are accomplished by a portable wireless terminal comprising: a first housing having an upper end curved in the shape of a semicircle, an open lower end, a slit circumferentially formed along the upper end, and a receiving space defined therein and extended inwardly from the open lower end in the longitudinal direction thereof; a second housing inserted into or drawn out from the receiving space of the first housing; and a camera lens unit mounted in the first housing, the camera lens unit having an exposure window circumferentially movable along the slit formed at the upper end of the first housing.

In accordance with another aspect of the present invention, there is provided a portable wireless terminal comprising: a housing having one end curved in the shape of a semicircle, and a slit circumferentially formed along the semicircular end; and a camera lens unit mounted in the housing, the camera lens unit having an exposure window circumferentially movable along the slit formed at the semicircular end of the housing.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a perspective view illustrating a portable wireless terminal according to a preferred embodiment of the present invention;

FIG. 2 is a perspective view of the portable wireless terminal illustrating a second housing of the portable wireless terminal inserted in a first housing of the portable wireless terminal illustrated in FIG. 1;

FIG. 3 is perspective view of the portable wireless terminal illustrating a camera lens unit of the portable wireless terminal illustrated in FIG. 1;

FIG. 4 is an exploded perspective view of the portable wireless terminal illustrating a camera lens unit of the portable wireless terminal illustrated in FIG. 1; and

FIG. 5 is a plan view of the camera lens unit illustrated in FIG. 4.

### DETAILED DESCRIPTION OF THE PREFERRED EMBODIMENTS

Preferred embodiments of the present invention will be described in detail herein below with reference to the accompanying drawings. In the following description, a detailed description of known functions and configurations incorporated herein will be omitted when it may make the subject matter of the present invention rather unclear.

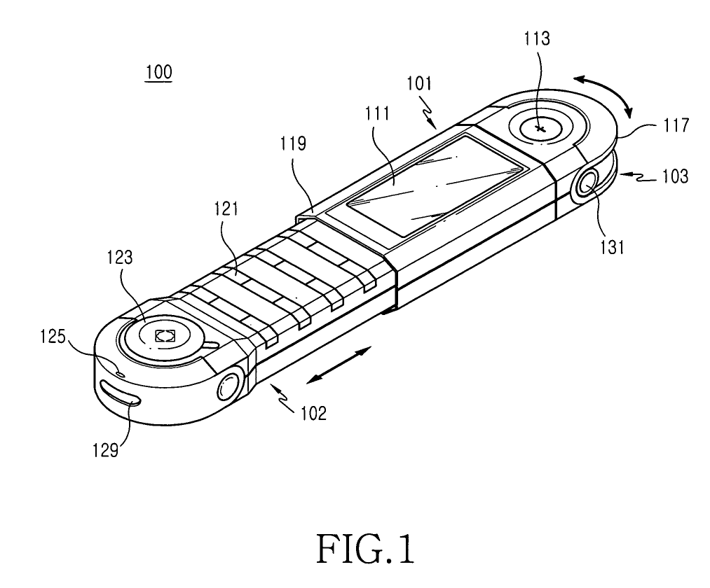

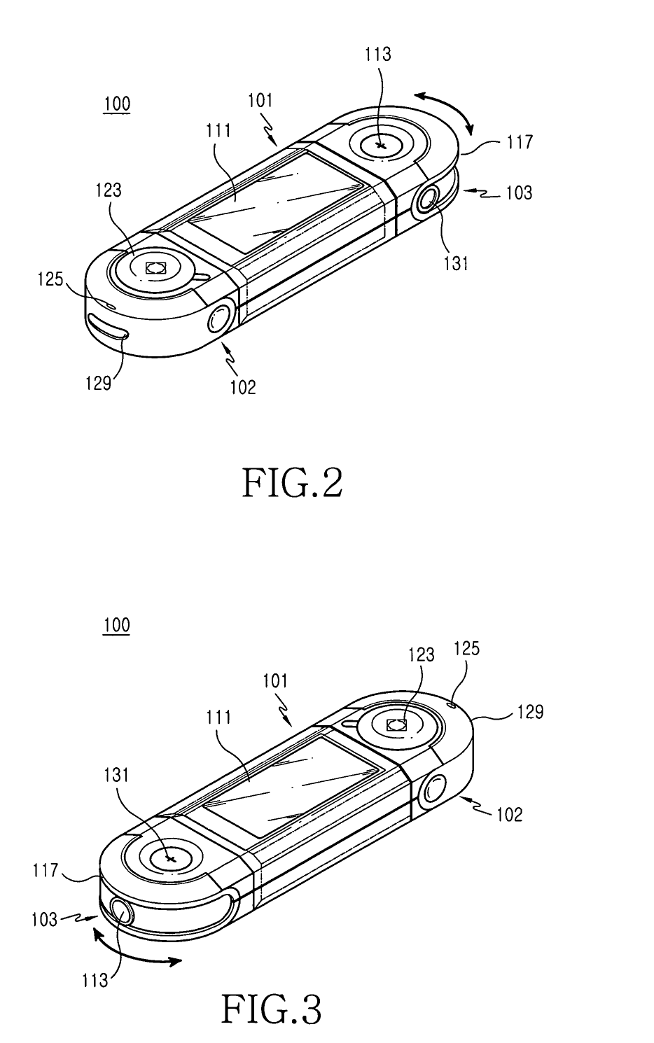

FIG. 1 is a perspective view illustrating a portable wireless terminal 100 according to a preferred embodiment of the present invention, FIG. 2 is a perspective view of the portable wireless terminal 100 illustrating a second housing 102 of the portable wireless terminal 100 inserted in a first housing 101 of the portable wireless terminal 100 illustrated in FIG. 1, and FIG. 3 is perspective view of the portable wireless terminal illustrating a camera lens unit 103 of the portable wireless terminal 100 illustrated in FIG. 1. As illustrated in FIGS. 1 to 3, the portable wireless terminal 100 of the present invention comprises the first housing 101, the second housing 102, and the camera lens unit 103.

The first housing 101 has a curved upper end 117 and an open lower end 119. The upper end 117 of the first housing 101 is preferably curved in the shape of a semicircle. The first housing 101 also has a receiving space defined therein. The receiving space is extended inwardly from the open lower end 119 in the longitudinal direction of the first housing 101. On the top surface of the first housing 101 are arranged a display unit 111 and a receiving unit 113 having a built-in speaker. The receiving unit 113 may be disposed on the semicircular upper end 117 of the first housing 101.

The second housing 102 has a curved lower end 129. The lower end 129 of the second housing 102 is preferably curved in the shape of a semicircle. On the top surface of the second housing 102 are arranged a keypad 121 comprising a plurality of key buttons, which are used to input data, such as characters and numerals, a navigation key 123, and a transmitting unit 125 having a built-in microphone. The navigation key 123 may be disposed on the semicircular lower end 129 of the second housing 102. The second housing 102 is moved in the longitudinal direction of the terminal 100 so that the second housing 102 is inserted into or drawn out from the receiving space of the first housing 101. When the second housing 102 is inserted into the first housing 101, the keypad 121 of the second housing 102 is hidden from the outside by means of the first housing 101. However, when the second housing 102 is drawn out from the first housing 101, the keypad 121 of the second housing 102 is exposed to the outside. Preferably, the navigation key 123 is always exposed to the outside irrespective of whether the second housing 102 is inserted into or drawn out from the first housing 101. Consequently, simple operations, such as data searching and function selection of the terminal, are conveniently performed on the display unit 111 by using the navigation key 123 even though the second housing 102 is inserted in the first housing 101.

The camera lens unit 103 is mounted to the curved upper end 117 of the first housing 101 in such a manner that an exposure window 131 of the camera lens unit 103 can be moved along the curved upper end 117 of the first housing 101. Preferably, the camera lens unit 103 is moved in the range of 180 degrees. Pictures taken by the camera lens unit 103 are displayed on the display unit 111 so that a user of the terminal can watch the pictures on the display unit 111. The user can search, transmit, or delete the pictures stored in the terminal 100 with the navigation key 123.

While the second housing 102 is drawn out from the first housing 101 as shown in FIG. 1, the user can answer the telephone or make a telephone call to another person with the portable wireless terminal 100. Alternatively, when the second housing 102 is inserted into the first housing 101 as illustrated in FIGS. 2 and 3, the portable wireless terminal 100 is set in a standby mode. In the standby mode, the use can conveniently take pictures and search data with the portable wireless terminal 100.

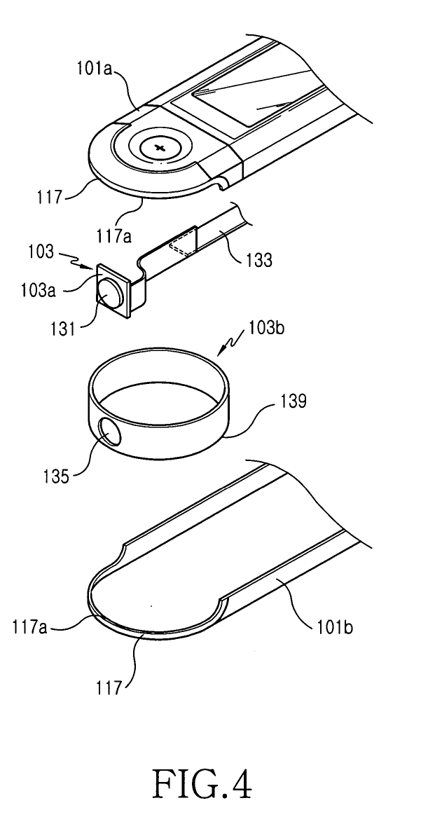

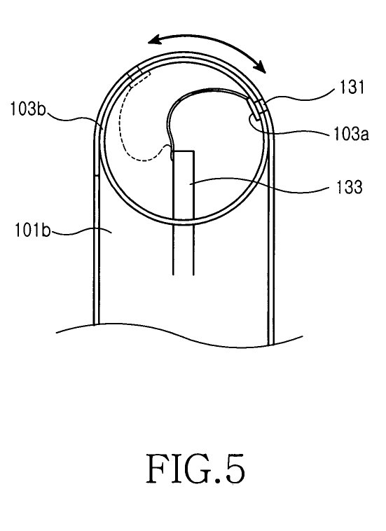

As illustrated in FIGS. 4 and 5, the camera lens unit 103 is mounted in the upper end 117 of the first housing 101. The upper end 117 of the first housing 101 is formed in the shape of a semicircle. A slip ring 103b, which is formed in the shape corresponding to that of the upper end 117 of the first housing 101, is mounted inside of the first housing 101nted. The slip ring 103b is slidably rotated while being in contact with the inner part of the upper end 117 of the first housing 101.

An exposure opening 135 is formed in the slip ring 103 in such a manner that the exposure opening 135 is penetrated from the outer circumferential surface thereof to the inner circumferential surface thereof. The exposure window 131 of the camera lens 103a is fitted in the exposure opening 135, and the camera lens 103a is fixed to the inner circumferential surface of the slip ring 103. The exposure window 131 of the camera lens 103a is disposed in a slit 117a formed at the upper end 117 of the first housing 101, which is defined by an upper housing part 101a of the first housing 101 and a lower housing part 101b of the first housing 101 attached to the upper housing part 101a of the first housing 101. Preferably, the slit 117a is circumferentially formed along the upper end 117 of the first housing 101 in the range of 180 degrees. Consequently, the exposure window 131 of the camera lens 103a is rotatable in the range of 180 degrees, that is, the full curve of the upper end 117.

A flexible printed circuit 133, which is inwardly extended from one side of the camera lens 103 through the gap between the lower end 139 of the slip ring 103b and the inner bottom surface of the lower housing part 101b of the first housing 101 is connected to the camera lens unit 103.

As is apparent from the description above, the present invention provides a portable wireless terminal comprising a first housing and a second housing, wherein the second housing can be inserted into or drawn out from the first housing. Consequently, the portable wireless terminal of the present invention has improved portability. In addition, a data search can be easily conducted using a navigation key even while the second housing is inserted in the first housing. Furthermore, a keypad is arranged on the second housing, whereby inadvertent pressing of the keypad is prevented when a user carries the portable wireless terminal of the present invention.

In addition, the portable wireless terminal includes a camera lens unit, which is rotatable in the range of 180 degrees, whereby it is very useful for a multimedia environment of a mobile communication service.

Although the preferred embodiments of the present invention have been disclosed for illustrative purposes, those skilled in the art will appreciate that various modifications, additions, and substitutions are possible, without departing from the scope and spirit of the invention as disclosed in the accompanying claims.

What is claimed is:

1. A portable wireless terminal comprising:
a first housing having an upper end curved in a semicircular shape, an open lower end, a slit circumferentially formed along the upper end, and a receiving space defined therein and extended inwardly from the open lower end in the longitudinal direction thereof;
a second housing capable of being inserted into and drawn out from the receiving space of the first housing; and
a camera lens unit mounted in the first housing, the camera lens unit having an exposure window circumferentially movable along the slit formed at the upper end of the first housing.

2. The terminal as set forth in claim 1, wherein the exposure window of the camera lens unit is rotated in a range of 180 degrees.

3. The terminal as set forth in claim 1, further comprising a display unit arranged on a top surface of the first housing for displaying pictures.

4. The terminal as set forth in claim 1, further comprising a keypad arranged on a top surface of the second housing, the keypad including a plurality of key buttons, wherein the keypad is hidden and exposed when the second housing is inserted into and drawn out from the receiving space of the first housing, respectively.

5. The terminal as set forth in claim 1, wherein the second housing has a lower end curved in a semicircle shape.

6. The terminal as set forth in claim 5, further comprising a navigation key arranged on a top surface of the second housing near the semicircular lower end of the second housing.

7. The terminal as set forth in claim 6, wherein the navigation key is always exposed irrespective of whether the second housing is inserted into or drawn out from the first housing.

8. A portable wireless terminal comprising:
a housing having one end curved in a semicircular shape, and a slit circumferentially formed along the semicircular end; and
a camera lens unit mounted in the housing, wherein the camera lens unit includes an exposure window circumferentially movable along the slit formed at the semicircular end of the housing.

9. The terminal as set forth in claim 8, wherein the camera lens unit comprises:
a slip ring capable of being slidably rotated, while being in contact with an inner part of the semicircular end of the housing;
an exposure opening penetrated from an outer circumferential surface of the slip ring to an inner circumferential surface of the slip ring;
a camera lens having an exposure window fixedly fitted in the exposure opening of the exposure opening; and
a flexible printed circuit inwardly extended from the camera lens through a gap between a lower end of the slip ring and an inner bottom surface of the housing.

10. The terminal as set forth in claim 8, wherein the slit is circumferentially formed along the semicircular end of the housing in a range of 180 degrees.

11. The terminal as set forth in claim 8, wherein the camera lens is rotated in a range of 180 degrees.
